(19) United States
(12) Patent Application Publication
(10) Pub. No.: US 2010/0039799 A1
(43) Pub. Date: Feb. 18, 2010

(54) COMBINED DAYLIGHT ELECTRIC LIGHT FIXTURE FOR BUILDINGS USING ELECTROCHROMIC AND MECHANICAL METHODS

(76) Inventor: KURT LEVENS, Borrego Springs, CA (US)

Correspondence Address: FELLERS SNIDER BLANKENSHIP;BAILEY & TIPPENS, THE KENNEDY BUILDING, 321 SOUTH BOSTON SUITE 800, TULSA, OK, 74103-3318, US

(21) Appl. No.: 12/506,767

(22) Filed: Jul. 21, 2009

Related U.S. Application Data
(60) Provisional application No. 61/082,386, filed on Jul. 21, 2008.

(51) Int. Cl. F21S 8/00

(52) U.S. Cl. 362/147

(57) ABSTRACT

A daylight fixture for replacing a 2′×2′ or 2′×4′ electric lighting fixture in a suspended ceiling grid that incorporates a lighting source. The fixture utilizes a diffuser that distributes sunlight emerging from the exit aperture of a skylit lightwell. The diffuser has multiple parts, including an element mounted above a light source for use in concomitant non-simultaneous distribution of daylighting and electric lighting into an interior space, and a diffusion element mounted below the electric lamp for lighting distribution thereby using diffusion and reflectance elements within the fixture to create desired illuminance distribution within an interior space. In one embodiment a light source and reflector may be positioned below the ceiling for directing illumination onto the ceiling plane for reducing the surface luminance of fixture components to within acceptable standards for interior illumination. Daylight is directed into a building interior from a horizontal roof plane instead of vertical wall planes.

### CROSS REFERENCE TO RELATED APPLICATIONS

This application claim priority to U.S. Provisional Patent Application No. 61/082,386 entitled “COMBINED DAYLIGHT ELECTRIC LIGHT FIXTURE FOR BUILDINGS USING ELECTROCHROMIC AND MECHANICAL METHODS,” filed Jul. 21, 2008, the contents of which are hereby incorporated by reference.

### FIELD OF THE INVENTION

The present invention relates generally to rooftop daylight fixtures that integrate skylights, light wells, and electric lighting and the manner in which illumination passing through and generated by this system is distributed to an interior space.

### BACKGROUND OF THE INVENTION

Rooftop daylight systems are becoming increasingly popular as a means to displace utility-provided electricity consumed in producing interior illumination. Rooftop daylight systems displace utility-provided electricity consumed in producing interior illumination. Basic solar mechanics can demonstrate that, on an annualized basis, there is more radiative energy available for collection through a horizontal rooftop aperture of a given size than for a similarly sized aperture along a vertical wall on any side of a building. Conventional skylights project unmodified solar beams into an interior, and are characterized by excessive contrast and high luminance/illumination ratio of interior environments. In the past, skylight technology has been burdened by highly contrasting and varying illumination levels at the workplane throughout the course of the day and the year. Engineering the diffusion of illumination as it passes through and interacts with components in a skylight/light well/diffuser system enables a large percentage of the solar volume admitted by the solar aperture to be brought into a space without the intensity of a direct solar beam, thereby improving the suitability of top-lighting for interior uses.

A large component of the radiative energy harvested by rooftop daylighting fixtures is diffuse sky radiation, whose behavior is highly predictable and largely uncontrollable. The directional component of the collected solar radiation can be optically controlled, but in the interest of ultimately diffusing this radiation for use as interior illumination, every attempt should be made to achieve diffusion without absorption and energy loss, and to do so in a manner that does not introduce any highly luminous surfaces or elements that would produce visual discomfort in the interior space. Diffusion may be introduced into the system at the skylight dome, along the surfaces of the light well, by elements placed at the exit aperture of the light well or below the aperture of the light well, or at any location in between. This disclosure relates to diffusion elements being placed within the fixture or below the exit aperture of a light well affixed to a skylight.

Daylight emerging from the end of a light well can be described as a directionally diffuse source. There are limits to what can be accomplished optically to change the characteristics of diffuse lighting, but within this diffuse element is a much larger directional component that can be optically controlled and which can be described with photometry that varies throughout the course of the day and year.

Diffusers placed at the exit aperture of a skylight or light well are not new. This application aligns a skylight/light well with a 2′×2′ or 2′×4′ suspended ceiling panel, which is constructed so that a conventional electric light fixture can be replaced with a natural light fixture of the same interior dimensions.

Technology exists for increasing the optical collection efficiency of skylight apertures, and for increasing the throughput efficiency of light tubes and light wells.

Generally, common ceiling-recessed 2′×4′ fluorescent downlighting fixtures are comprised of a reflective upper panel that redirects illumination downward through a louver or diffuser into a space to be lighted. The interaction between the reflector/diffuser/fixture geometries result in a specific photometric characterization for every lighting fixture. This invention replaces the reflectors used to redirect the illumination emitted from a lighting source in conventional lighting fixtures, and the rear supporting structure of the fixture, with diffusers, or some other combination of reflection and diffusion media, to allow photosensitive transformation in the passage of daylight and reflection of electric light.

### SUMMARY OF THE INVENTION

Embodiments herein relate generally to skylights and the manner that illumination from skylights is integrated into an interior space. Embodiments herein relate to the characterization of a lighting fixture using daylight as a source, a transparent glazing element enclosing a solar aperture at the building envelope elevated above the roof plane by a curb element, and a light well, which is a mechanism for transferring solar illumination from an aperture exposed to that source to an illumination distributing fixture located at or below the ceiling plane in the interior of the building. The illumination distributing lighting fixture can closely approximate the form, function, and style of conventional electric lighting fixtures.

Side-lighting naturally accommodates a time dependent upward illumination component for distribution within a space. Top-lighting most generally accommodates a downward, time dependent illumination component. The invention of the disclosure improves the feasibility of utilizing top-lighting for interior uses that the building and construction industry has to date reserved for side admitted daylighting.

A large component of the radiative energy harvested by daylighting fixtures is diffuse sky radiation. The behavior of diffuse sky radiation is highly predictable and largely uncontrollable. The directional component of the collected solar radiation can be optically controlled, but in the interest of ultimately diffusing this radiation for use as interior illumination, every attempt should be made to achieve diffusion without absorption and energy loss, and to do so in a manner that does not introduce any highly luminous surfaces or elements that would produce visual discomfort in the interior. Diffusion may be introduced into the system at the skylight dome, along the surfaces of the light well, by elements placed at the exit aperture of the skywell or below the aperture of the skywell, or at any location in between. This disclosure relates to diffusion elements being placed within the fixture or below the exit aperture of a light well affixed to a skylight.

Daylight emerging from the end of a light well can be described as a directionally diffuse source. There are limits to what can be accomplished optically to change the characteristics of diffuse lighting, but within this diffuse element is a much larger directional component that can be optically controlled and which can be described with photometry that varies throughout the course of the day and year.

Diffusers placed at the exit aperture of a skylight or skywell are not new. This application positions a skylight/skywell that may be substantially aligned with a 2′×2′ or 2′×4′ suspended ceiling panel, which is constructed so that a conventional electric light fixture can be replaced with a natural light fixture of the same interior dimensions.

To accommodate maximum utilization of skylighting within an interior space, the distributing light fixture is affixed to or suspended beneath the exit aperture of a skylit lightwell, which may be located at the ceiling plane, to receive emitted light. Through a combination of diffusing and reflecting surfaces, a direct/indirect, semi-direct/indirect, indirect/semi-direct illumination distribution can be attained for achieving for predictable illumination levels that satisfy pertinent IES Guidelines and Standards for specific lighting applications. Embodiments herein include a type of fixture that interacts with the end of a lightwell to attain specified illumination distributions.

Energy losses within skylit lightwells contribute to diffusing the emission of daylight into building interiors. Interior inter-reflections that occur along the length of the lightwell contribute to a decrease in throughput efficiency of skylighting because of absorption that occurs at each bounce of light rays. Scattering improves the uniformity in daylight distribution emitted from the exit of a skylit skywell aperture, but is considered a loss factor because a portion of the scattered illumination is projected upward and back out of the collection system.

Technology exists for increasing the optical collection efficiency of skylight apertures, and for increasing the throughout efficiency of skytubes and skywells.

Generally, common ceiling-recessed 2×4 fluorescent downlighting fixtures are comprised of a reflective upper panel that redirects illumination downward through a louver or diffuser into a space to be lighted. The interaction between the reflector/diffuser/fixture geometries results in a specific photometric characterization for every lighting fixture. Embodiments herein replace the reflectors used to redirect the illumination emitted from a lighting source in conventional lighting fixtures, and the rear supporting structure of the fixture, with diffusers, or some other combination of reflection and diffusion media, to allow photosensitive transformation in the passage of daylight and reflection of electric light.

### BRIEF DESCRIPTION OF THE DRAWINGS

FIG. 1 is a top view of a combined daylight electric fixture.

FIG. 2 is a side view of combined daylight electric fixture of FIG. 1.

FIG. 3 is a building interior view of the underside of the combined daylight electric fixture of FIG. 1.

FIG. 4 shows an embodiment of the combined daylight electric fixture of FIG. 1 utilizing an electrochromic diffuser, the underside of which becomes reflective when photo-activated.

FIG. 5 is a side cutaway view of an illumination distribution fixture of the daylight electric fixture of FIG. 1

FIG. 6 is a bottom view of the illumination distribution fixture in which the reflectors are in a retracted position.

FIG. 7 is an illumination distribution fixture in which the reflectors are partially deployed.

FIG. 8 is an illumination distribution fixture in which the reflectors are fully deployed, providing indirect illumination.

FIG. 9 is a cross-section of an illumination distribution fixture of the daylight electric fixture of FIG. 1 with a diffuser placed above deployable reflective panels.

FIG. 10 is a cross-section of a fixture with the reflective louver in an open position.

FIG. 11 is a cross-section of a fixture with the reflective louver in a partially retracted position.

FIG. 12 is a cross-section of a fixture with the reflective louver in a closed position with the exterior illumination rejected and electric illumination reflected below.

FIG. 13 is a perspective view of an embodiment of an electric daylight fixture that provides indirect electric illumination.

FIG. 14 is a partial cross-sectional perspective view of the daylight fixture of FIG. 13.

FIG. 15A is an enlarged partial cross-sectional perspective view of the embodiment of FIG. 13.

FIG. 15B is an enlarged perspective view of the upper diffuser segment of FIG. 15.

FIG. 16 is a perspective view of an additional embodiment of a daylight fixture.

### DETAILED DESCRIPTION OF THE PREFERRED EMBODIMENTS

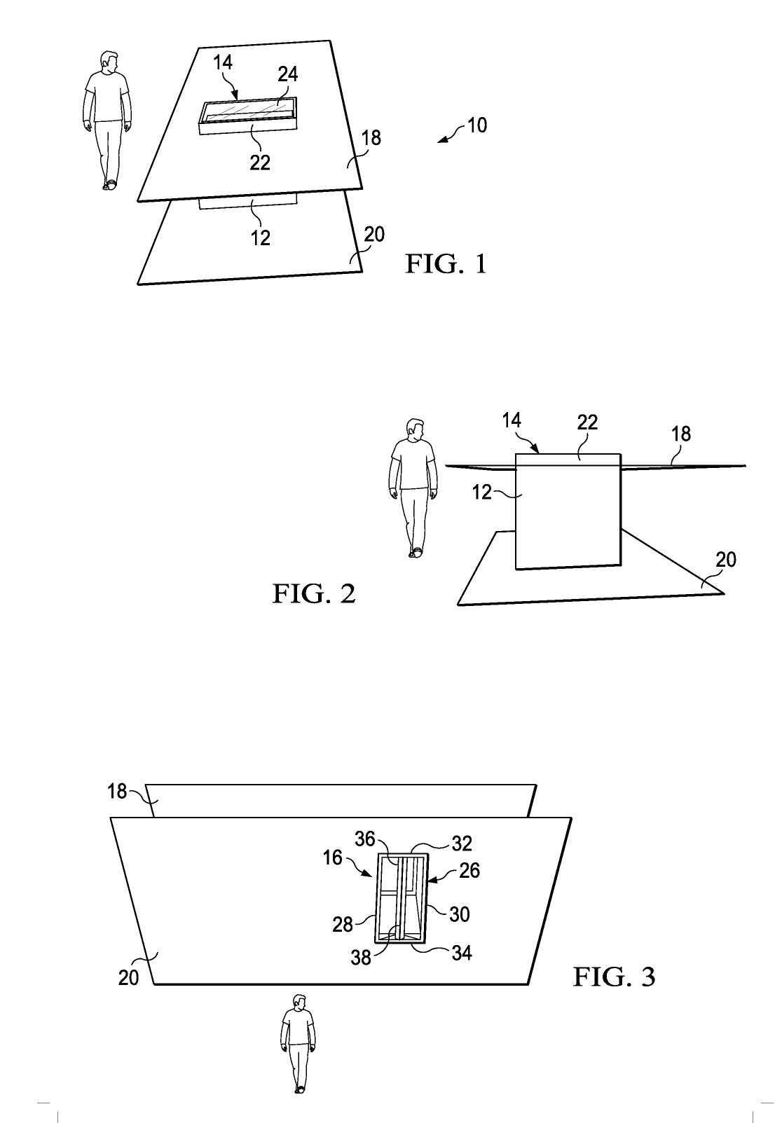

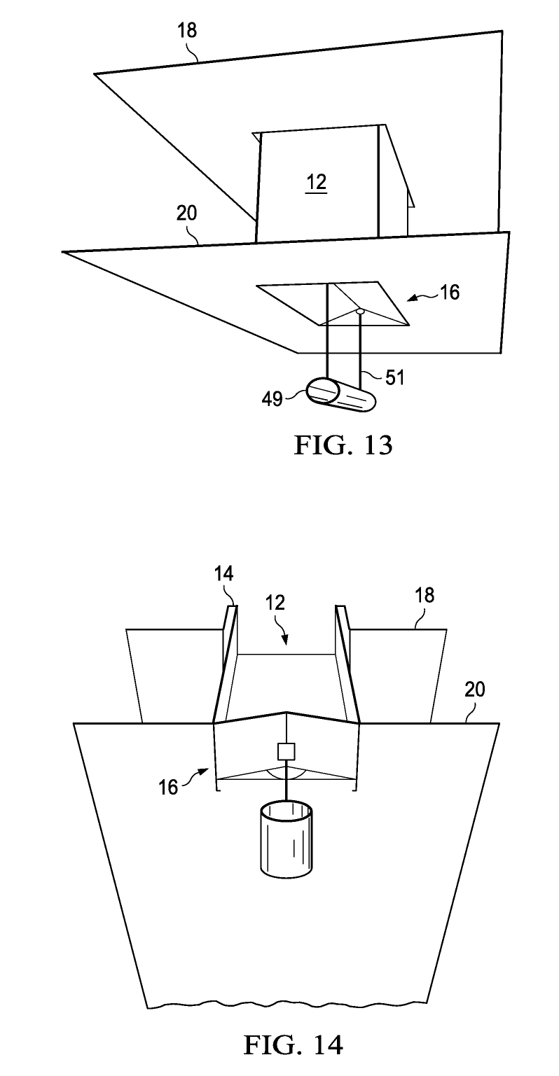

A daylight fixture 10 of the invention has light well 12 that defines solar aperture 14 on an upper end and defines exit aperture 16 (FIGS. 3-16) on a lower end. Lightwell 12 may extend above roof plane 18. Lower end of lightwell 12 is preferably coplanar with ceiling plane 20. An interior of lightwell 12 is reflective. A portion of light well 12 that extends above roof plane 18 is referred to herein as curb portion 22 (FIGS. 1, 2, 10-16). Skylight 24 (FIG. 1) or transparent glazing portion is provided to cover solar aperture 14.

Illumination distribution fixture 26 (FIGS. 5, 9-12, 15A) is affixed to light well 12 adjacent to exit aperture 16. Illumination distribution fixture 26 includes first side wall 28, second side wall 30, first end wall 32 and second end wall 34. Illumination distribution fixture 26 further includes integrated electric light assembly 36 (FIGS. 5-9).

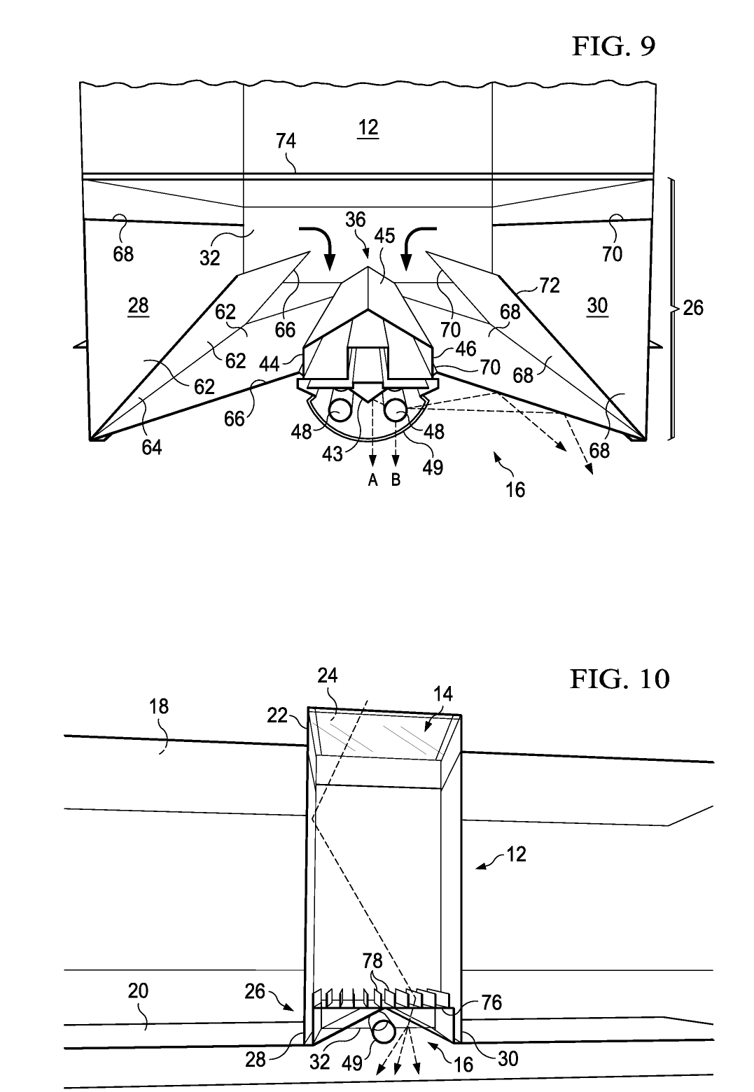

Integrated light assembly 36 includes light assembly support 38 having first support end 40, second support end 42, first support side 44 and second support side 46. First support end 40 of light assembly support 38 is affixed to a lower middle portion of first end wall 32 of illumination distribution fixture 26. Second support end 42 of light assembly support 38 is affixed to a lower middle portion of second end wall 30 of illumination distribution fixture 26. Reflector 43 (FIGS. 5, 9) may be affixed to an underside of light assembly support 38. Reflector 45 (FIGS. 5, 9) may be provided to cover the length of light assembly support 38. Lighting element 48 (FIGS. 5, 9) is affixed to a lower surface of light assembly support 38. Protective member/diffuser 49 (FIGS. 5, 9) may be affixed to light assembly support 38 and extend below lighting element 48.

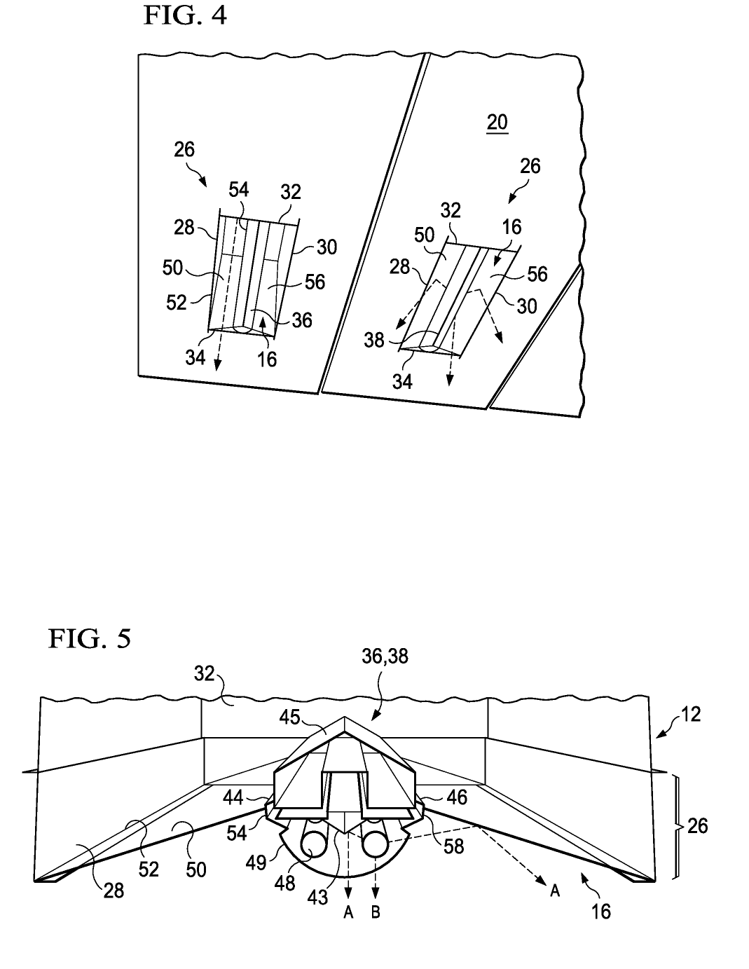

In one embodiment, electro-chromatic diffusers are provided to selectively allow light to pass through the diffusers or to provide reflective surfaces on an underside of the diffusers, as is best seen in FIG. 5. First electro-chromatic diffuser 50 has a first side 52 and a second side 54. First side 52 of first electro-chromatic diffuser 50 is supported by first side wall 28 of illumination distribution fixture 26. Second side 54 is supported by first support side 44 of light assembly support 38. First electro-chromatic diffuser 50 is selectively actuatable to be either substantially transparent (see, e.g., left side of FIG. 4) or substantially reflective (see, e.g., right side of FIG. 4).

Referring back to FIG. 5, second electro-chromatic diffuser 56 has a first side 58 and a second side 60. First side 58 of second electro-chromatic diffuser 56 is supported by second support side 46 of light assembly support 38. Second side 60 is supported by second side wall 30 of illumination distribution fixture 26. Second electro-chromatic diffuser 56 is selectively actuatable to be either substantially transparent (see, e.g., left side of FIG. 4) or substantially reflective (see, e.g., right side of FIG. 4).

In a second embodiment, reflective panels are provided that may be positioned in a deployed configuration for reflecting light off of a lower surface or the reflective panels may be positioned in an non-deployed configuration to allow light to pass through exit aperture 16 of light well 12. As may be best seen in FIG. 9, first reflective panel 62 has first side 64 and second side 66. First reflective panel 62 is supported on first side 64 by first side wall 28 of illumination distribution fixture 26. First reflective panel 62 is supported on second side 66 by first support side 44 of light assembly support 38. First reflective panel 62 may be selectively positioned to be either in a deployed or non-deployed configuration.

Still referring to FIG. 9, second reflective panel 68 has a first side 70 and a second side 72. Second reflective panel 68 is supported on first side 70 by second support side 46 of light assembly support 38. Second reflective panel 68 is supported on second side 72 by second side wall 30 of illumination distribution fixture 26. Second reflective panel 68 may be selectively positioned to be either in a deployed or non-deployed configuration.

Diffuser 74 may be positioned above integrated electric light assembly 36. Diffuser 74 is positioned a distance above electric light assembly 36 sufficient to permit first reflective panel 62 and second reflective panel 68 to open fully into a non-deployed configuration.

In a third embodiment, louver tray 76 is located above light assembly support (not shown) that supports protection member/diffuser 49 that houses light source 48. Louver tray 76 has a plurality of louvers 78 that extend from first end wall 32 to second end 34 wall of illumination distribution fixture 26. Each louver 78 is pivotal about a longitudinal axis from an open vertical orientation (FIG. 10) to a closed horizontal orientation (FIG. 12).

The surfaces of the fixtures, e.g., first electro-chromatic diffuser 50, second electro-chromatic diffuser 60, first reflective panel 62, second reflective panel 64, and louvers 78, may have optical characteristics that partially transmit or partially reflect light, or may be perforated to allow simultaneous transmission from above and reflection from below. Since light enters solar aperture 14 from above during sunlight hours, and light entering the system 10 from below is during non-sunlight hours, two methods for accommodating complimentary operational modes are described below. The first method is electrically based, the second is mechanically based.

In the first embodiment, shown in FIGS. 4 and 5, electro-chromaticity enables daylight fixture diffusers 50, 56 to retain transparency and distribute sunlight when non-activated and to function as electric lighting fixtures when sunlight is unavailable. Silvered electro-chromaticity is defined here to refer to a material applied to, or within, a rigid or semi-rigid substrate that will change from clear to highly reflective when a photo-sensitive voltage is applied. In FIG. 4, silvered electro-chromic diffusers (50, 56) are de-activated in the left illumination distribution fixture 26 and when photo-sensitively activated, become reflective on their undersides, as shown in the right illuminated distribution fixture 26 of FIG. 4 to distribute electric lighting into the interior space below the light fixture.

Electric light 48 may be a linear lamp protected by translucent louver 49 on its underside, as shown in FIG. 5. The electro-chromic diffusers 50, 56 rest upon the side of an integrated electric light assembly 36 within an illumination distribution fixture 26. The electric light assembly is comprised of lamps 48 whose backward directed light (A) is reflected downward by reflector 43 and an activated silvered electro-chromic reflector 56. Downward directed light (B) and reflected light (A) pass through diffuser 49 so that the brightness or intensity of light is reduced before entering into the space below fixture 10. When photo-sensitively activated, to become reflective on the undersides of electro-chromic diffusers 50, 56 and become part of the supplemental electric lighting system, which could be a linear lamp 48 protected by a translucent louver 49 on its underside.

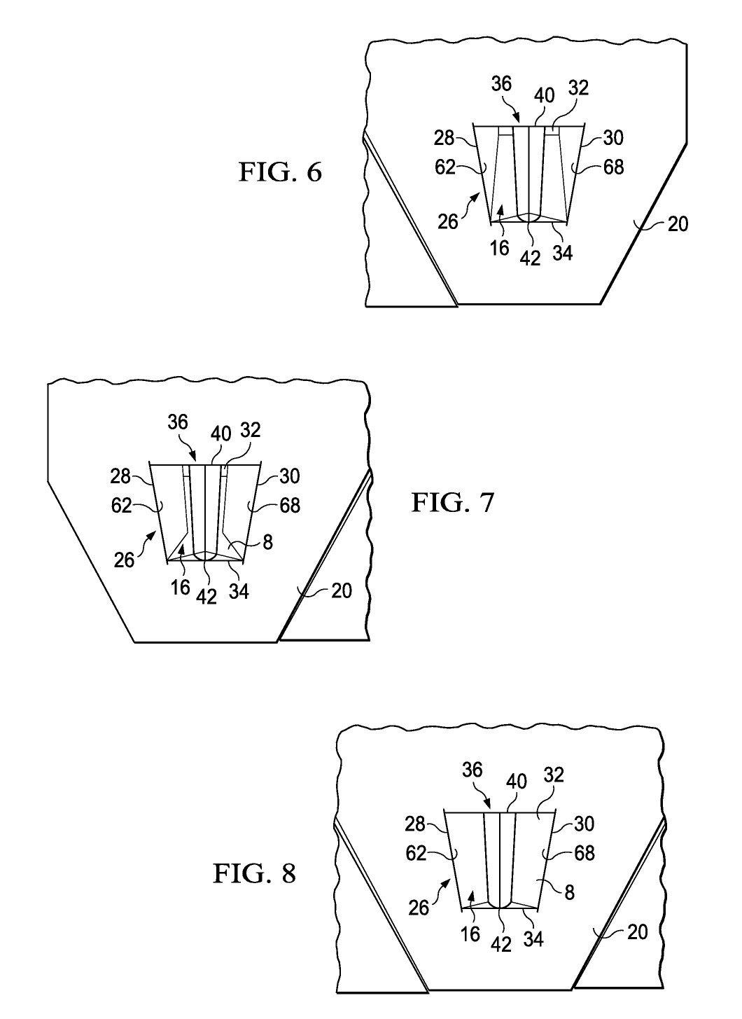

In a second embodiment (FIGS. 6-8), fixtures are to be fitted with reflective panels 62, 68 that pivot down onto light assembly support 38 when activated. In a preferred embodiment, deployment of reflective panels 62, 68 are photo activated. As shown in FIG. 6, retractable reflective panels 62, 68 are positioned in an open un-deployed position when the system 10 is delivering sunlight to the building interior. Reflective panels 62, 68 may be hinged along the long sides of illumination distribution fixture 26 and lay on top of a portion of light assembly support 38 when fully deployed (FIG. 8). The fully deployed configuration shuts off the daylight component and enables efficient reflection of the indirect lighting component of electric source 48. Since reflective panels 62, 68 could be fitted with thermally insulting material, and since low light exterior conditions occur at the same time as heat loss through the fixture/light well is highest, these reflective panels will increase the U-Value of the daylight system, and significantly improve their thermal performance. FIG. 7 illustrates a partial deployment of the reflective panels.

FIG. 9 further illustrates the physical organization of a hybrid electric light fixture 10 with retractable panels 62, 68. Retractable downwardly reflective panels 62, 68 are shown in open, partially open, and fully closed positions. The fully open and fully closed positions are functioning positions. The intermediary position occurs during activation and deactivation of electric source 48. Light rays (A) emitted from electric lamp 48 are reflected by reflector 43 within the integrated light assembly 36 of the illumination distribution fixture 26, and by the deployed retractable reflective panels 62, 68. Light rays (B) emitted by the electric lamp in downward direction are diffused by a lamp diffuser 49 so that lamp brightness is reduced before entry into the interior space below the fixture. Sunlight diffuser 74 may be placed far enough above the deploying reflectors 62, 68 to allow them to move from a vertical (de-activated) position to a horizontal (activated position).

In an alternative configuration of the second embodiment of this disclosure, diffuser 74 is placed far enough above the deploying reflectors 62, 68 to allow reflectors 62, 68 to move from a vertical (de-activated) position to a horizontal (activated movement, see cutaway of FIG. 9 for illustration of partial deployment). The underside of reflectors 62, 68 would redirect upward components of illumination from electric source 48 downward into the space below. Reflective surfaces could also be placed on the upper sides of the deploying reflectors 62, 68 to send radiation back out of the building envelope, when used as a solar shading device, to reduce the amount of solar illumination reaching the interior space. Diffuser 74 may be constructed of a highly insulative material, as may the substrate of reflectors 62, 68, so that the overall convective and conductive heat loss/gain characteristics of fixture 10 are minimized.

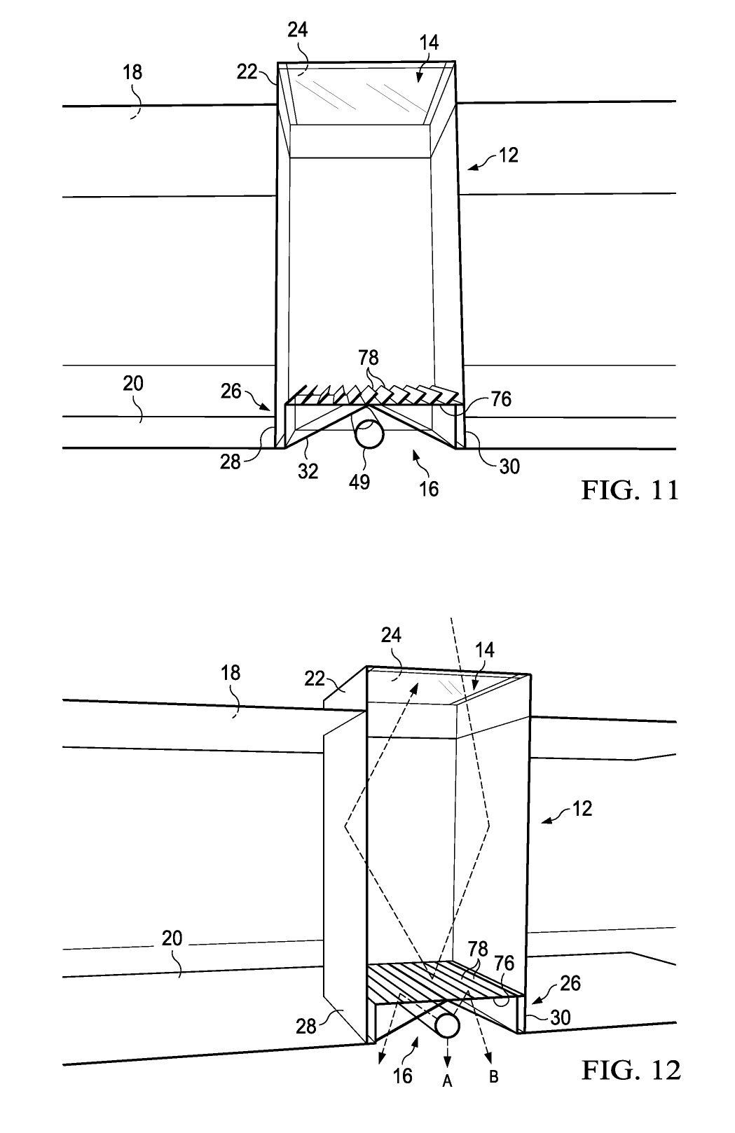

An alternative configuration of the second embodiment would utilize a system of adjustable louvers 78 (FIGS. 10-12). This would enable diffuser 74 to sit lower in illumination distribution fixture 26, but is functionally equivalent to the embodiment of FIG. 9. FIG. 10 illustrates a cross section of fixture 10 with reflective louvers 78 in an open position. FIG. 11 illustrates the same system in a partially retracted position. In either of these positions, daylight is admitted into the interior space below, and much of the illumination generated by the electric source 48 would escape through the top of the fixture. FIG. 12 illustrates the louvers 78 in a closed position such that exterior illumination is rejected out of the system and electric illumination (A, B) is reflected into the interior space of the building.

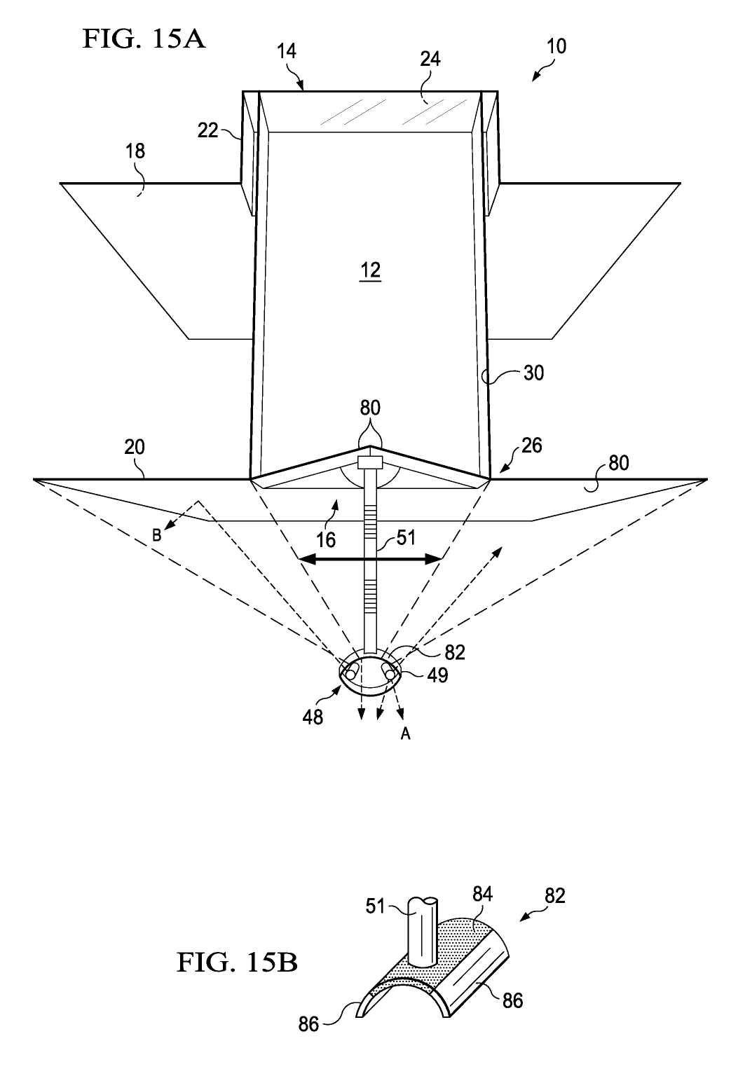

Referring now to FIG. 15A, in an additional embodiment of the invention, a daylight fixture has a lightwell 12 that defines a solar aperture 14 on an upper end. Lightwell 12 additionally has an exit aperture 16 on a lower end that is proximate a ceiling plane 20. A diffuser 80 is located within lightwell 12 proximate to exit aperture 16. A light source 48 is suspended below diffuser 80 on a vertical member 51. An upper diffuser segment 82 is affixed to the lower end of vertical member 51. Upper diffuser segment 82 is located adjacent to light source 48 and has an opaque center section 84. A lower diffuser segment 86 is also located adjacent to light source 48. Opaque center section 84 is sized to prevent upwardly directed light from light source 48 from projecting on aperture 16 of lightwell 12, but is sized to allow other upwardly projecting light to shine on ceiling plane 20 through translucent section 86. Additionally, opaque center section 84 is preferably provided with a reflective upper surface to redirect light passing through lightwell 12 and diffuser 80 upwardly toward roof plane 20.

Exit aperture 16 of daylight fixture 79 can incorporate components described previously in the disclosure, such as silvered electrochromic, drop down reflectors, or simple diffusers, for effecting various electric/solar light distributions.

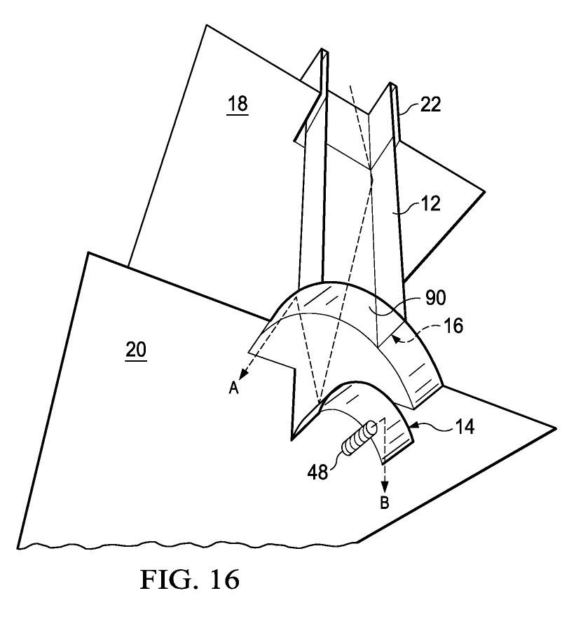

Another embodiment of a hybrid daylight electric light fixture that provides non-simultaneous electric light and engineered diffuse daylight is shown in FIG. 16. The fixture creates an upward component of sunlight within the fixture with a lightwell 12, a clear, translucent or transitional electrochromic diffuser 90 through which sunlight A passes, a double sided downwardly concave reflector 92, the top surface of which reflects sunlight A passing through the diffuser 90 in an upward direction, and the bottom surface of which reflects, in a generally downward direction, electric light B generated by an electric lamp 48 placed below it, and an optional diffuser (not shown) placed below the electric lamp 48 for diffusing the downwardly directed illumination produced by the lamp 48.

Thus, the present invention is well adapted to carry out the objectives and attain the ends and advantages mentioned above as well as those inherent therein. While presently preferred embodiments have been described for purposes of this disclosure, numerous changes and modifications will be apparent to those of ordinary skill in the art. Such changes and modifications are encompassed within the spirit of this invention as defined by the claims.

What is claimed is:

1. A daylight fixture comprising:
a lightwell defining a solar aperture on an upper end and an exit aperture on a lower end;
an illumination distribution section of said lightwell proximate to said exit aperture, said illumination distribution section having a first side wall and a second side wall;
a light source supported within said illumination distribution section;
a light barrier above said light source within said illumination distribution section, said light barrier for selectively blocking light entering said lightwell via said solar aperture, said light barrier having a reflective lower surface for redirecting upwardly directed light from said light source into a space below said illumination distribution section.

2. The daylight fixture according to claim 1 wherein:
said upper end of said lightwell extends above a roof plane of a building; and
said lower end of said lightwell is coplanar with a ceiling plane of said building.

3. The daylight fixture according to claim 1 further comprising:
a skylight structure covering said solar aperture.

4. The daylight fixture according to claim 1 wherein:
said illumination distribution section has a first end wall and a second end wall;
said light source is supported by a light assembly support having a first end, a second end, a first side and a second side, said light assembly support affixed at a center of said first end wall and at a center of said second end wall of said illumination distribution section; and wherein
said light source is affixed to a lower surface of said light assembly support.

5. The daylight fixture according to claim 4 further comprising:
a protective member/diffuser affixed to said light assembly support and extending below said light source.

6. The daylight fixture according to claim 1 wherein:
said light barrier is an electro-chromatic diffuser.

7. The daylight fixture according to claim 4 wherein said light barrier comprises:
a first electro-chromatic diffuser having a first side and a second side, said first side of said first electro-chromatic diffuser pivotally affixed to said first side wall of said illumination distribution section, said second side of said first electro-chromatic diffuser supported by said light assembly support, said first electro-chromatic diffuser selectively actuatable to be either substantially transparent or substantially reflective;
a second electro-chromatic diffuser having a first side and a second side, said first side of said second electro-chromatic diffuser supported by said light assembly support and said second side of said second electro-chromatic diffuser pivotally affixed to said second side wall of said illumination distribution section, said second electro-chromatic diffuser selectively actuatable to be either substantially transparent or substantially reflective.

8. The daylight fixture according to claim 1 wherein:
said light barrier is a reflective panel.

9. The daylight fixture according to claim 4 wherein said light barrier is comprises:
a first reflective panel having a first side and a second side, said first side of said first reflective panel pivotally affixed to said first side wall of said illumination distribution section and said second side of said first reflective panel supported by said light assembly support, said first reflective panel selectively positioned to be either in a deployed or non-deployed configuration;
a second reflective panel having a first side and a second side, said first side of said second reflective panel supported by said light assembly support and said second side of said second reflective panel pivotally affixed to said second side wall of said illumination distribution section, said second reflective panel selectively positioned to be either in a deployed or non-deployed configuration.

10. The daylight fixture according to claim 8 further comprising:
a diffuser above said light source a distance sufficient to permit said reflective panel to open fully into a non-deployed configuration.

11. The daylight fixture according to claim 1 wherein:
said light barrier is a plurality of louvers.

12. The daylight fixture according to claim 1 wherein:
said illumination distribution section has a first end wall and a second end wall; and further comprising:
a louver tray above said light assembly support, said louver tray having a plurality of louvers extending from said first end wall to said second end wall of said illumination distribution section, each of said plurality of louvers pivotal about their longitudinal axis from an open vertical orientation to a closed horizontal orientation.

13. A daylight fixture comprising:
a lightwell defining a solar aperture on an upper end and an exit aperture on a lower end, said exit aperture proximate a ceiling plane;
a diffuser within said lightwell proximate said exit aperture;
a light source suspended below said diffuser;
an upper diffuser segment adjacent said light source, said upper diffuser segment having an opaque center section;
a lower diffuser segment adjacent said light source;
wherein said opaque center section is sized to prevent upwardly directed light from said light source from projecting on said exit aperture, but which allows other upwardly directed light from said light source to shine on said ceiling plane.

14. The daylight fixture according to claim 13 wherein an upper surface of said opaque center section is reflective to redirect light entering through said lightwell back toward ceiling plane.

15. A daylight fixture comprising:
a lightwell defining a solar aperture on an upper end and exit aperture on a lower end;
an illumination distribution section of said lightwell proximate to said exit aperture, said illumination distribution section having a first side wall and a second side wall;
a light assembly support having a first side and a second side, said light assembly support located within said illumination distribution section, said light assembly support having a reflective member on a lower surface;
a light source supported by said light assembly support;
a diffuser supported by said light assembly support and passing beneath said light source;
a first electro-chromatic diffuser affixed to said first side wall of said illumination distribution section at a first edge and supported by said first side of said light assembly support at a second edge;
a second electro-chromatic diffuser affixed to said second side wall of said illumination distribution section at a second edge and supported by said second side of said light assembly support at said first edge;
wherein said first electro-chromatic diffuser and said second electro-chromatic diffuser selectively achieve reflective lower surfaces for redirecting upwardly directed light from said light source.

16. A daylight fixture comprising:
a lightwell defining a solar aperture on an upper end and an exit aperture on a lower end;
a shaped diffuser having outer portions adjacent a ceiling plane and a central portion that rises above said ceiling plane, wherein said exit aperture communicates with said shaped diffuser, said shaped diffuser permitting light from said lightwell to pass therethrough, said shaped diffuser having a reflective lower surface;
a double sided reflector below said shaped diffuser, said double sided reflector having an upper reflective surface and a lower reflective surface, said upper reflective surface for redirecting light passing through said shaped diffuser in an upward direction;
a light source below said double sided reflector;
wherein said lower reflective surface redirects light from said light source in a downward direction.

17. The daylight fixture according to claim 16 wherein:
said shaped diffuser is arch shaped having a first side and a second side, wherein said first side and said second side communicate with said ceiling plane.

18. The daylight fixture according to claim 16 wherein:
said double sided reflector is smaller and mimics the shape of said shaped diffuser.
